(19) United States
(12) Patent Application Publication
(10) Pub. No.: US 2015/0154662 A1
(43) Pub. Date: Jun. 4, 2015

(54) OUTPUT DEVICE CAPABLE OF OUTPUTTING ADDITIONAL PAGE, METHOD FOR OUTPUTTING ADDITIONAL PAGE, AND RECORDING MEDIUM HAVING PROGRAM RECORDED THEREON FOR EXECUTING METHOD

(71) Applicant: Hun-Kyung Kim, Seoul (KR)

(72) Inventor: Hun-Kyung Kim, Seoul (KR)

(73) Assignee: SPINNOTE CO., LTD., Seoul (KR)

(21) Appl. No.: 14/406,305

(22) PCT Filed: Aug. 13, 2012
(86) PCT No.: PCT/KR2012/006436

§ 371 Date: Dec. 8, 2014

(30) Foreign Application Priority Data
Jun. 8, 2012 (KR) 10-2012-0061552

(51) Int. Cl. G06Q 30/02

(52) U.S. Cl. CPC G06Q 30/0277

(57) ABSTRACT

A method of outputting an additional page includes: a first step of applying a note change signal for changing a note current outputted on a display unit; and a second step of moving a first note displayed on the display unit to gradually disappear to a side on a screen, moving a new second note to gradually appear on the screen sequentially from the first note, and outputting an additional page between the two notes. By using the apparatus for outputting an additional page, the method of outputting an additional page, and a recording medium having a program for implementing the method, it is possible to output an additional page without covering an image with a note, selectively output advertisements in an additional page in accordance with user's inclination, and expose an additional page to the view of a user, thereby improving usability of an additional page.

### BACKGROUND OF THE INVENTION

1. Field of the Invention

The present invention relates to a technology of additionally displaying an additional page (or a secondary page) other than an output page selected by a user, and more particularly, to an output device capable of outputting additional page, and a method for outputting additional page, and a recording medium having program recorded thereon for executing method.

2. Description of the Related Art

Recently, with the advent of various media for providing information, various types of advertisements for publicizing products and companies have been developed. In particular, with the development of the internet that anyone can easily access at any time and at any place, using portable terminals, various types of advertisements for users of the internet have been developed.

A type of advertisement in the related art is described hereafter in detail with reference to the accompanying drawings.

FIG. 1 illustrates a screen of a terminal with an advertisement outputted in a type of existing advertisement.

As illustrated in FIG. 1, a type of outputting a note 10 selected by a user on a display unit 2 of a portable terminal 1 and outputting and fixing an additional page 20 with an advertisement at any portion (lower end in FIG. 1) in the note 10 when a user wants to put the advertisement in the outputted image has been generally used. However, most users look at the other area except the area where the additional page 20 with an advertisement is outputted, so the type of outputting and fixing the advertisement window 20 at any portion on the display unit 2 has poor advertisement efficiency.

Further, since a portion of the image outputted on the display unit 2 is covered with the advertisement window 20, users feel inconvenience in seeing the note 10 and they have to remove the advertisement through a specific operation in order to see the entire note 10. Further, the advertisement window 20 of the related art provides the same advertisements to all of users regardless of the users' inclination, so the advertisement effect is very insignificant.

### SUMMARY OF THE INVENTION

An aspect of the present invention provides an apparatus for outputting an additional page which can output an additional page not covering the image of a note, selectively output advertisements in the additional page in accordance with users' inclination, and expose the additional page in an area within the users' view, a method of outputting an additional page, and a recording medium having a program for implementing the method.

According to an aspect of the present invention, there is provided a method of outputting an additional page that includes: a first step of applying a note change signal for changing a note current outputted on a display unit; and a second step of moving a first note displayed on the display unit to gradually disappear to a side on a screen, moving a new second note to gradually appear on the screen sequentially from the first note, and outputting an additional page between the two notes.

The method may further include: a third step of receiving a signal for enlarging the second page, with the second page outputted; a fourth step of gradually removing the notes on the screen and gradually enlarging the second page on the screen; a fifth step of receiving a signal for returning the additional page; and a sixth step of returning the areas for outputting the note and the additional page to the state before the third step.

The notes outputted on the display unit may be notes selected in advance by a user and then arranged, and the second step may sequentially show the notes on the screen in accordance with an arrangement order set by the user.

The notes maybe arranged circularly and moved along an arc and the additional page may be outputted in a triangular shape between adjacent two notes.

The notes may be grouped in accordance with the kinds of their contents and group name sections showing the kinds of the notes may be additionally displayed.

A notice or an advertisement may be outputted on the additional page.

An advertisement designated for the contents of a note outputted on the display unit may be outputted on the additional page.

The second step may include a process of information about a note outputted on the display unit to an advertisement transmission server, a process in which the advertisement transmission server selects an information designated to the note of which the information received and transmits the advertisement to a control unit controlling output of the display unit, and a process in which the control unit outputs the advertisement transmitted from the advertisement transmission server to an additional page.

When there is no advertisement designated for the contents of a note outputted on the display unit, a default advertisement may be outputted on the additional page.

When a user inputs a signal for enlarging an image and a signal for reducing an image, a note and an additional page outputted on the display unit may be enlarged and reduced, and when a user inputs a signal for reducing an image, three or more notes may be outputted on the display unit in a predetermined arrangement pattern.

The display unit may be a touch screen, and when a user touches the display unit at a plurality of points and drags the points in parallel in a predetermined direction, the note and the additional page may be reduced or enlarged in the dragging direction.

The display unit may be a touch screen, and when a user double taps the display unit and drags a contact object, a note and an additional page may be reduced or enlarged in the dragging direction.

When the notes and the additional page are reduced and any one of the note and the additional page is touched, the touched note or the additional page may be enlarged and outputted.

The display unit may be a touch screen and the note change signal in the first step may be considered as a sweeping signal that is inputted to the display unit.

The third step may consider that a signal for enlarging an additional page is inputted, when a contact object inputting the sweeping signal is separated from the display unit or sweeping by the contact object is stopped over a predetermined time.

According to another aspect of the present invention, there is provided a computer-readable recording medium that keeps a program for performing the method of outputting an additional page according to the present invention.

According to another aspect of the present invention, there is provides an apparatus for outputting an additional page that includes: a display unit; an input unit that receives a note change signal for changing a note outputted on the display unit to another note; and a control unit that controls output of the display unit so that a first note outputted on the display unit moves and gradually disappears to a side, anew second note moves and gradually appears on a screen sequentially from the first note, and an additional page is outputted between the two notes, when the note change signal is inputted to the input unit.

The control unit may control output of the display unit so that notes selected in advance by a user are sequentially outputted.

On the display unit, a plurality of notes may be arranged and outputted circularly, and when the note change signal is inputted, the notes may be moved along an arc and the additional page may be outputted in a triangular shape or a fan shape between two adjacent notes.

The notes may be grouped in accordance with the kinds of their contents and group name sections showing the kinds of the notes may be outputted on the display unit.

A notice or an advertisement may be outputted on the additional page.

An advertisement designated for the contents of a note outputted on the display unit may be outputted on the additional page.

The control unit may transmit information about a note outputted on the display unit to an advertisement transmission server, the advertisement transmission server may select and transmits an advertisement designated for the note of which the information is received to the control unit, and the control unit may output the advertisement transmitted from the advertisement transmission server to an additional page.

When there is no advertisement designated for the contents of a note outputted on the display unit, a default advertisement may be outputted on the additional page.

The display unit may enlarge, reduce, and then output the note and the additional page when a signal for enlarging an image and a signal for reducing an image are inputted, and may output three or more notes in a predetermined arrangement pattern when a signal for reducing an image is inputted.

The display unit may be a touch screen and may reduce or enlarge and output the note and the additional page in a dragging direction, when two or more contact objects touch the display unit at a plurality of points and then are dragged in parallel in a predetermined direction.

The display unit may be a touch screen and may reduce or enlarge and output the note and the additional page in a dragging direction, when a contact object double taps the display unit and then dragged on the display unit.

When the notes and the additional page are reduced and any one of the note and the additional page is touched, the touched note or the additional page may be enlarged and outputted. The display unit may be a touch screen and the input unit may recognize a sweeping signal inputted to the touch screen as a note change signal.

The input unit may determine that a signal for enlarging a secondary signal is inputted, when a contact object inputting a sweeping signal is separated from the display unit or sweeping of the contact object is stopped over a predetermined time.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates an image showing an advertisement on a terminal which is outputted in a type of existing advertisement;

FIG. 2 is a block diagram of an apparatus for outputting an additional page according to the present invention;

FIG. 3 is a flowchart illustrating a method of outputting an additional page according to the present invention;

FIGS. 4 and 5 are diagrams illustrating exemplary use of the apparatus for outputting an additional page according to the present invention;

FIG. 6 is a diagram illustrating output of the entire additional page;

FIGS. 7 to 9 are diagrams sequentially illustrating a process of outputting an additional page;

FIGS. 10 and 11 are diagrams illustrating a process of outputting an additional page according to another embodiment;

FIGS. 12 to 14 are diagrams sequentially illustrating a process of contracting an additional page;

FIG. 15 is a diagram illustrating arrangement of notes; and

FIG. 16 is a diagram illustrating a display unit added with a function button.

### DETAILED DESCRIPTION OF THE PREFERRED EMBODIMENT

Exemplary embodiments of the present invention will now be described in detail with reference to the accompanying drawings.

An output device capable of outputting additional page, and a method for outputting additional page, and a recording medium having program recorded thereon for executing method according to the present invention will be described hereafter with reference to the accompanying drawings. Hereinafter, an additional page means a secondary page, secondary window, auxiliary page or auxiliary window.

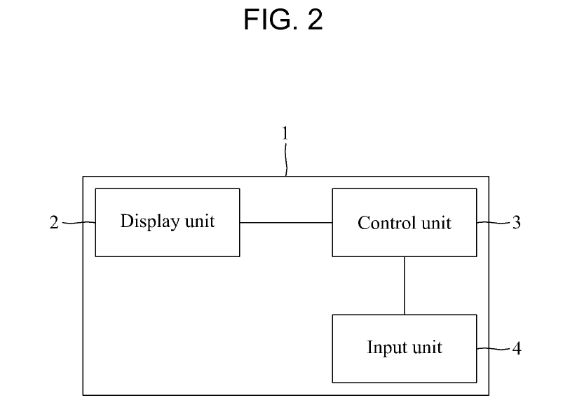

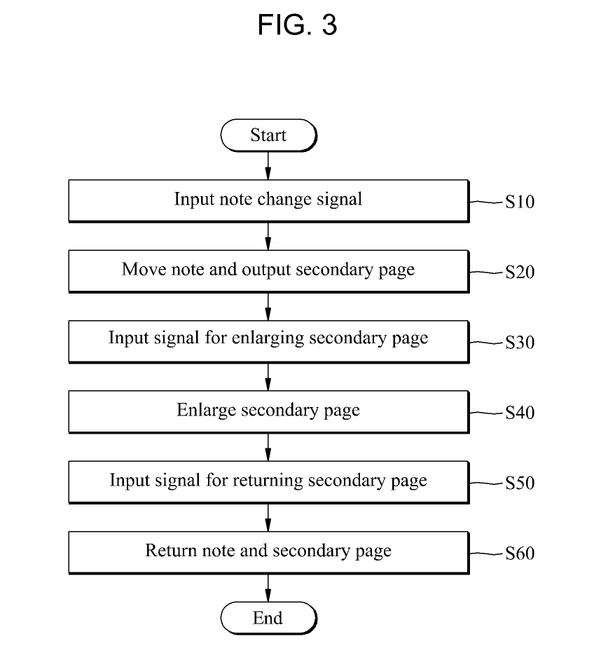

FIG. 2 is a block diagram illustrating an apparatus for outputting an additional page according to the present invention and FIG. 3 is a flowchart illustrating a method of outputting an additional page according to the present invention.

An apparatus 1 for outputting an additional page according to the present invention includes a display unit 2 that outputs an image (hereafter, referred to as a ‘note 100’) which is outputted to make a page, an input unit 4 that receives a signal from the outside, and a control unit 3 that controls the outputting of the display unit 2 in accordance with a signal transmitted to the input unit 4. The input unit 4 can receive a note change signal for changing a note 100 outputted on the display unit 2 to another note 100 and the control unit 3 controls the display unit 2 to remove a first note 101 that has been outputted on the display unit 2 from the screen and output a new note 100, that is, a second note 102 on the screen, when a note change signal is inputted to the input unit 4. When the display unit 2 is a touch screen, the display unit 2 and the input unit 4 are integrated.

In the related art, when the first note 101 that has been outputted on the display unit 2 disappears and the new second note 102 is shown, the second note 102 is shown sequentially from the first note 101, so there is no space between the first note 101 and the second note 102. However, the apparatus 1 for outputting an additional page according to the present invention is the most characterized in that when the first note 101 that has been outputted on the display unit 2 and the second note 102 is shown, a space is generated between the first note 101 and the second note 102 and the space is used for outputting an additional page 200. The process of outputting the additional page 200 and the advantages obtained by outputting the additional page 200, as described above, will be described below with reference to specific figures.

A method of outputting an additional page according to the present invention additionally outputs the additional page 200 other than the note 100, using the apparatus 1 for outputting an additional page which includes the display unit 2, the control unit 3, and the input unit 4, in which when a note change signal for changing the note 100 on the display unit 2 is supplied (S10), the first note 101 on the display unit 2 gradually disappears to a side on the screen, a new second note 102 gradually appears, following the first note 101, and the additional page 200 is outputted between the notes 100 (S20). When a signal for enlarging the additional page 200 is supplied, with the additional page 200 outputted (S30), the note 100 gradually disappears from the screen and the additional page 200 is gradually enlarged (S40). When a signal for returning the additional page 200 is supplied, with the additional page 200 enlarged (S50), the area for outputting the note 100 and the additional page 200 returns to the state before the enlargement (S60). According to the method of outputting an additional page of the present invention, the additional page 200 is not outputted when it is not in used, but is outputted when the note 100 is changed, so the interference with a user seeing the note 100 due to the additional page 200 covering the note 100 is prevented.

A process of outputting the additional page 200 is described hereafter with reference to the accompanying drawings.

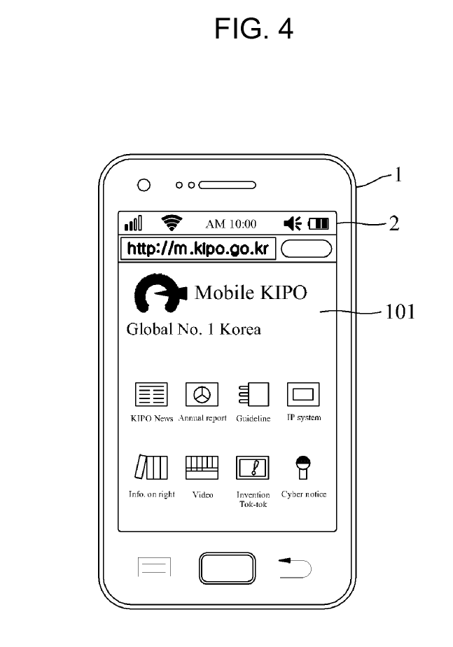

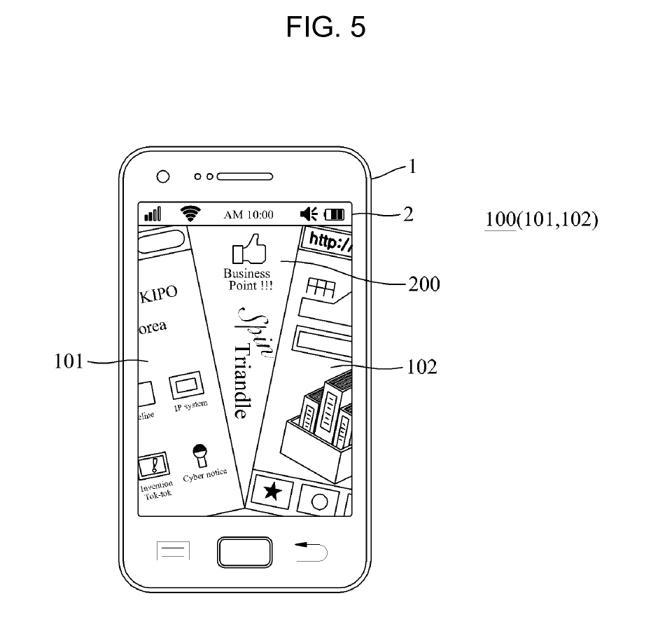

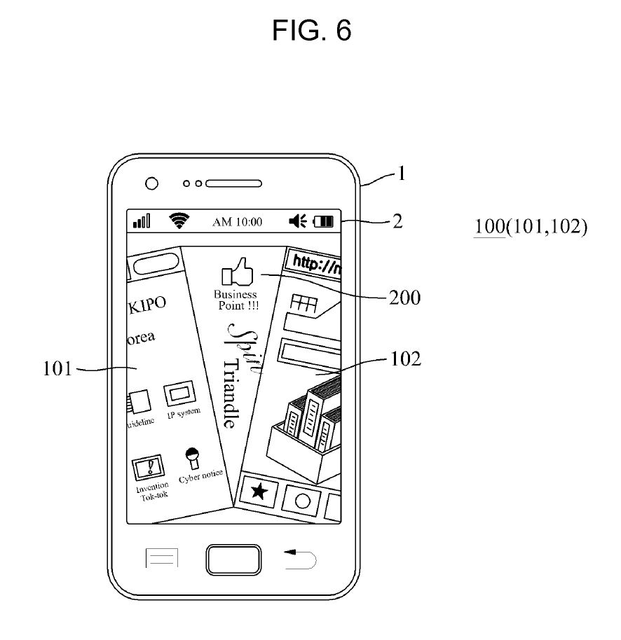

FIGS. 4 and 5 are diagrams illustrating exemplary use of the apparatus 1 for outputting an additional page according to the present invention and FIG. 6 is a diagram illustrating output of the entire additional page 200.

According to the apparatus 1 for outputting an additional page of the present invention, as illustrated in FIG. 4, when any one note 100, that is, the first note 101 is outputted throughout the screen of the display unit 2, the additional page 200 is not outputted, but when a user inputs a sweeping signal through the display unit 2, the input unit 4 recognizes the sweeping signal as a note change signal, so, as illustrated in FIG. 5, the first note 101 moves to aside (the left in the embodiment) on the display unit 2 and a new note 100, that is, the second note 102 appears on the display unit 2, following the first note 101.

The first note 101 and the second note 102 are generally outputted in a rectangular shape, and are not arranged and moved horizontally, but they are arranged along an arc about a rotational axis and turned along the arc, such that a triangular empty space is necessarily formed between the first note 101 and the second note 102. According to the apparatus 1 for outputting an additional page of the present invention, the triangular empty space is used as the area for outputting the additional page 200, so it is possible to improve usability of the area and preclude the note 100 from being covered by the additional page 200. In this embodiment, although the additional page 200 is outputted in the shape of a triangle, it maybe outputted in a fan shape between the first note 101 and the second note 102.

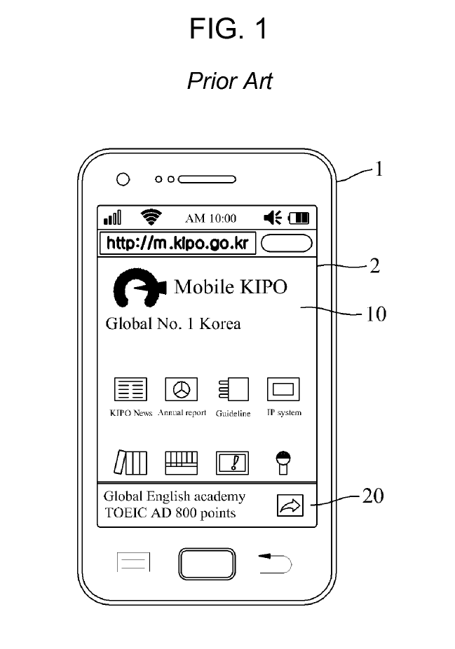

On the other hand, the advertisement window 20 of the related art illustrated in FIG. 1 is positioned at the lower portion on the display unit 2, out of the main view of a user, that is, the center portion of the screen of the display unit 2. However, as illustrated in FIG. 5, the second page 200 outputted between the two notes 100 passes the main view of a user, that is, the center portion of the screen of the display unit 2, so the informing effect is considerably increased, when official announcement or an advertisement is put on the additional page 200.

Further, as illustrated in FIG. 4, when the note 100 fully fills the screen of the display unit 2 is turned, as illustrated in FIG. 5, a portion of the top of the additional page 200 between the first note 101 and the second note 102 cannot exposed to the outside, out of the screen of the display unit 2. Accordingly, in the apparatus 1 for outputting an additional page of the present invention, the first note 101 and the second note 102 may be outputted at a predetermined reduction ratio, as illustrated in FIG. 6, when they are moved in response to a note change signal so that the entire additional page 200 can be outputted on the screen of the display unit 2. Obviously, when there is no problem with using the additional page 200 even if a portion of the top of the additional page 200 is not outputted on the screen, the sizes of the first note 101 and the second note 102 are maintained, even though they are moved in response to a note change signal.

When an advertisement is set to be outputted on the additional page 200, an advertisement designated for the contents of the note 100 outputted on the display unit 2, in detail, an advertisement relating to the contents of the note 100 outputted on the display unit 2 may be set to be outputted on the additional page 200. That is, the control unit 3 of the apparatus 1 for outputting an additional page according to the present invention connects with the internet, receives the information about the note 100 that is currently outputted on the display unit 2, and transmits the information to an advertisement transmission server, the advertisement transmission server selects and transmits an advertisement designated for the contents of the note 100 to the control unit 3 of the apparatus 1 for outputting an additional page in accordance with what contents the note 100 currently outputted on the display unit 2 includes, and the control unit 3 can output the advertisement transmitted from the advertisement transmission server on the additional page 200. For example, when the note 100 currently displayed on the display unit 2 is a note 100 relating to a vehicle, an advertisement for auto insurance may be outputted on the additional page 200 when the note 100 is changed, and when the note 100 currently outputted on the display unit 2 is a note 100 relating to camping, an advertisement for a tent may be outputted. As described above, when advertisements designated for the kinds of notes 100 are outputted in accordance with what contents are in the note 100 currently outputted, a user intensively sees the advertisement in the field that he/she is interested in, and accordingly, the advertisement effect is greatly increased.

When an advertisement is not designated for the note outputted on the display unit 2, a default advertisement may be set to be outputted on the additional page 200. Similarly, when it is difficult to clearly know which kind of note 100 the note current outputted is, a default advertisement may be set to be outputted. The default advertisement may be periodically changed at predetermined time.

The apparatus 1 for outputting an additional page according to the present invention, as described above, may receive and output an advertisement selected and transmitted by a specific advertisement transmission server on the display unit 2, or it may keep various advertisements, determine in person the contents of the note 100 currently outputted, and then output an advertisement designated for the contents. When the apparatus 1 for outputting an additional page according to the present invention can keep various advertisements and select an advertisement to be outputted in person, it is possible to output an appropriate advertisement even if communication is impossible. Obviously, there may be a need for a specific storage (not illustrated) for keep various advertisement.

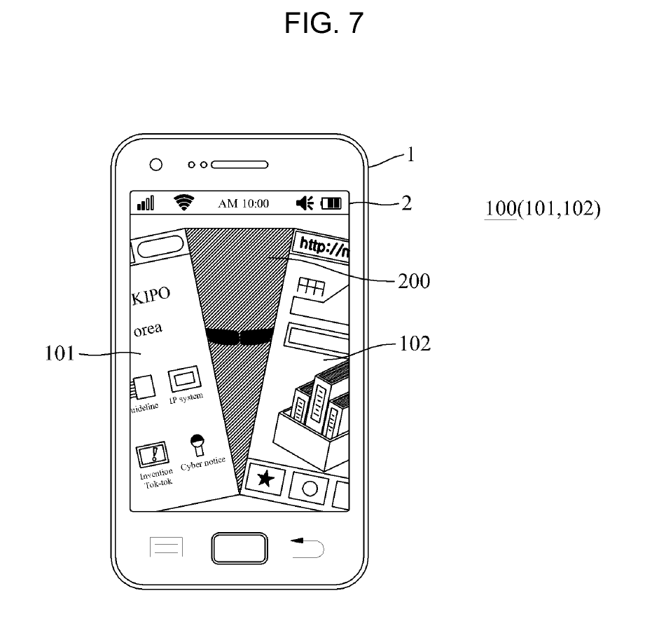

FIGS. 7 to 9 are diagrams sequentially illustrating a process of displaying the additional page 200.

When a note change signal is supplied to change the note 100 outputted on the display unit 2 to another note 100, as illustrated in FIGS. 5 and 6, the first note 101 and the second note 102 are partially outputted and the additional page 200 is outputted between the notes, in which the additional page 200 is significantly smaller in size than the note 100, so it is difficult to put a lot of contents on the additional page 200. Accordingly, the apparatus 1 for outputting an additional page according to the present invention may enlarge the additional page 200 outputted at a portion of the screen of the display unit 2.

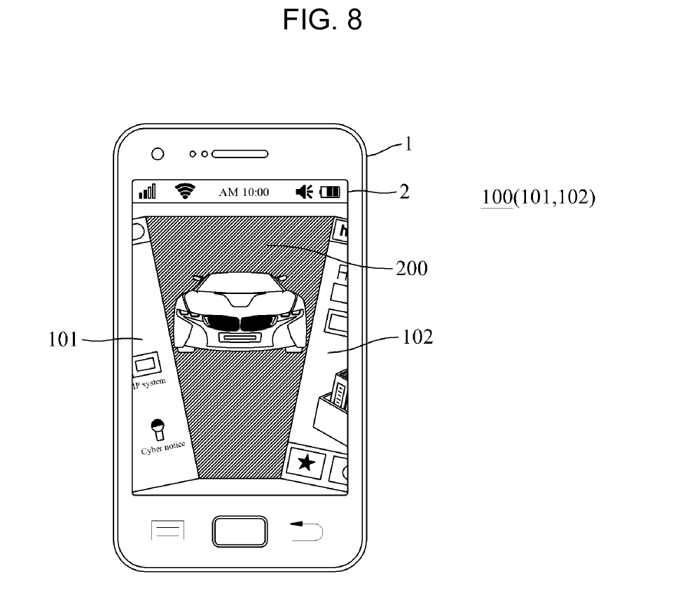

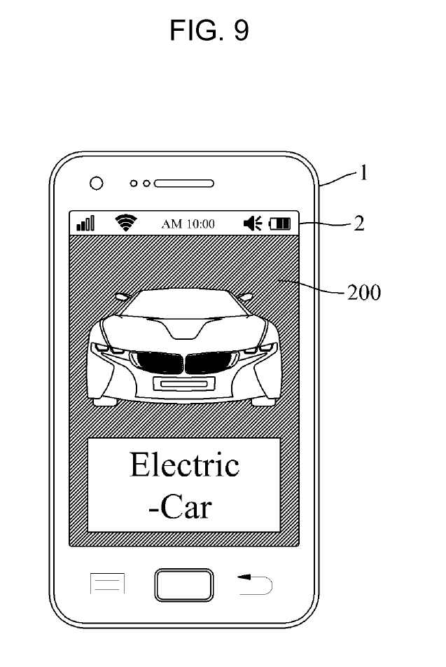

That is, according to the apparatus 1 for outputting an additional page of the present invention, when a signal for enlarging the additional page 200 is supplied, with the additional page 200 outputted relatively small, as illustrated in FIG. 7, the first note 101 and the second note 102 outputted on the display unit 2 open to the left and right and gradually disappear from the screen, as illustrated in FIG. 8, and the additional page 200 gradually enlarges and fully fills the space between the first note 101 and the second note 102. As the first note 101 and the second note 102 keep opening and the additional page 200 keep enlarging, finally, the first note 101 and the second note 102 all disappear and the additional page 200 fully fills the screen of the display unit 2, as illustrated in FIG. 9. As described above, when the additional page 200 increases and fully fills the screen of the display unit 2, more contents can be put on one additional page 200. Further, as the additional page 200 increases in size, it is possible to make more dynamic notices and advertisements by changing graphics or copy outputted through the additional page 200.

Smartphones or portable terminals are equipped with touch screens, as the display unit 2, so users generally put a finger on the display unit 2 and drag or sweep a note 100 outputted on the touch screen in order to change the note 100 to another note 100. Accordingly, the note change signal may be set as a drag signal or a sweeping signal. The apparatus 1 for outputting an additional page according to the present invention may be set such that a signal for enlarging the additional page 200 is generated when an additional external force is applied to the display unit 2, a signal for enlarging the additional page 200 is generated when a note 100 that is being dragged or swept to a side is stopped for a predetermined time, or a signal for enlarging the additional page 200 is generated when the contact object (a finger when a user drags or sweeps the note with the finger) that is dragging or sweeping a note 100 to a side is separated from the display unit 2.

As illustrated in FIG. 9, when a signal for returning the additional page 200, with the additional page 200 outputted throughout the screen of the display unit 2, the first note 101 and the second note 102 starts to appear from the left and right sides of the display unit 2, as illustrated in FIG. 8 and returns to the state illustrated in FIG. 7. The apparatus 1 for outputting an additional page according to the present invention may recognize a touch signal as the signal for returning the additional page 200, when the touch signal is inputted to the display unit 2 in the state illustrated in FIG. 9, or may recognize a drag signal or a sweeping signal as the signal for returning the additional page 200.

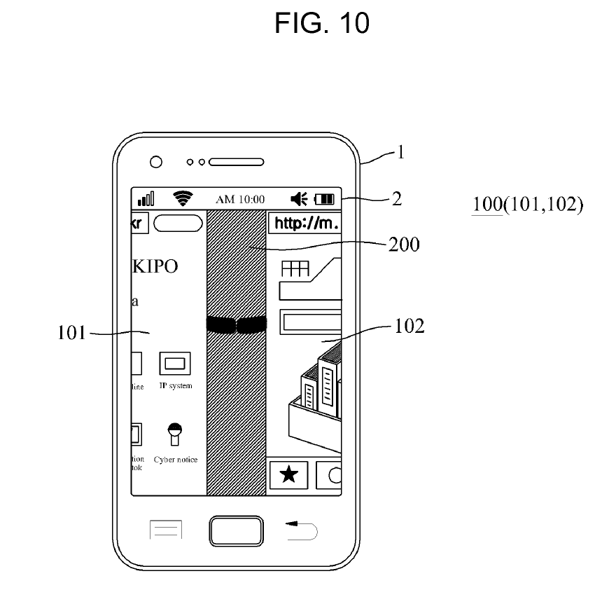

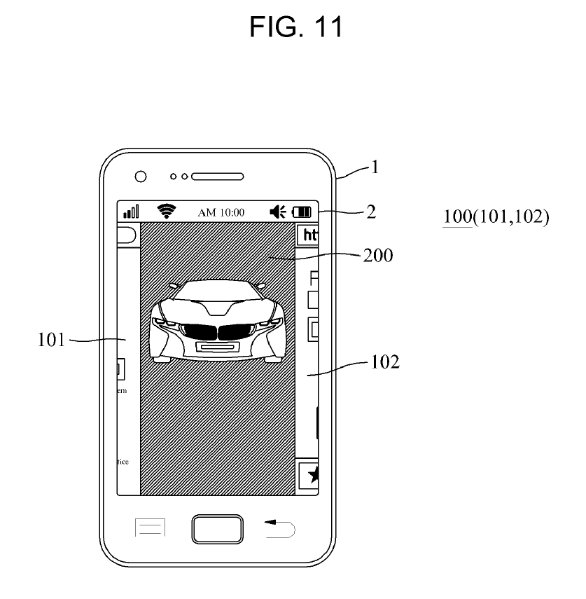

FIGS. 10 and 11 are diagrams illustrating a process of displaying the additional page 200 according to another embodiment.

According to the apparatus 1 and the method of outputting an additional page of the present invention, a plurality of notes 100 may be arranged not in a circle, but sequentially in a predetermined direction. Obviously, when a plurality of notes 100 is arranged sequentially in a predetermined direction, adjacent two notes 100 may move, maintaining a predetermined gap therebetween so that the additional page 200 can be outputted in the gap between the notes 100.

For example, adjacent two notes 100 are arranged laterally and a note change signal is supplied, the notes 100, as illustrated in FIG. 10, move laterally and the additional page 200 is outputted between the notes 100. In the state illustrated in FIG. 10, when a user stops the finger dragging or sweeping or gets it off the display unit 2, the first note 101 and the second note 102 are moved to the left and right of the display unit 2, as illustrated in FIG. 11, such that the additional page 200 is outputted throughout the screen of the display unit 2, as illustrated in FIG. 9.

Although lateral arrangement of the first note 101 and the second note 102 is exemplified in this embodiment, the first note 101 and the second note 102 maybe arranged longitudinally so that the first note 101 and the second note 102 are moved up and down, when a signal for enlarging the additional page 200 is inputted.

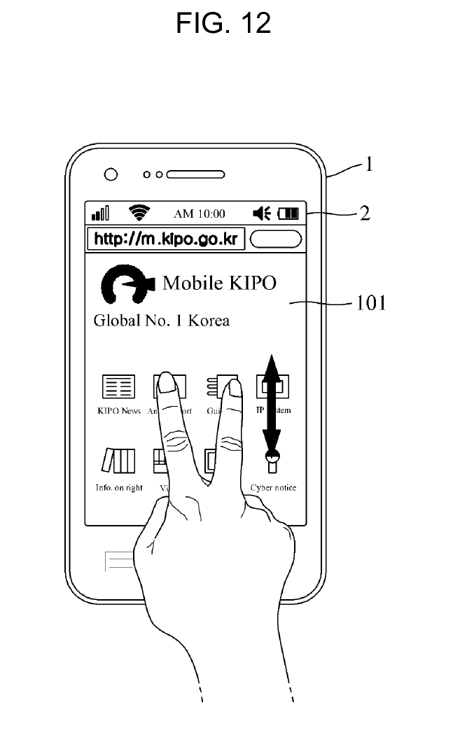

FIGS. 12 to 14 are diagrams sequentially illustrating a process of contracting an additional page.

In general, smartphones or portable terminals are set such that one note 100 is outputted throughout the screen and the size of the note 100 outputted on the screen cannot be adjusted by a user. Accordingly, when a user keeps several notes 100 in a smartphone or a portable terminal and executes a menu for selecting a note 100 that he/she wants to see, the kept notes 100 are outputted too small, so it is difficult to discriminate the contents in the notes.

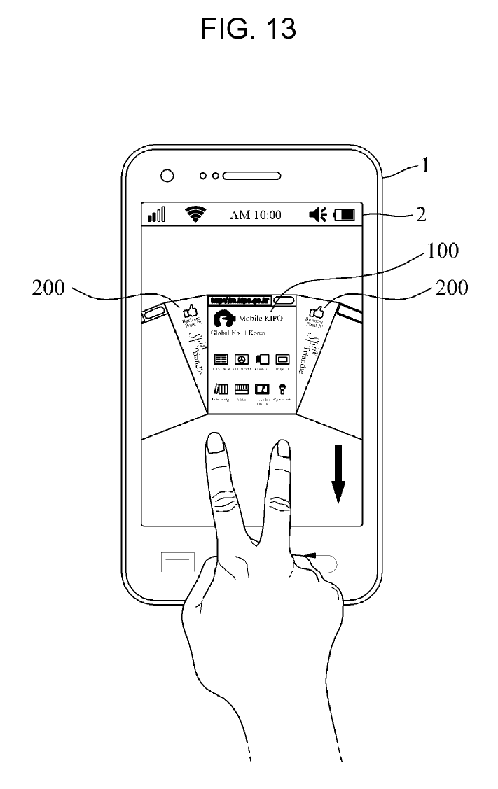

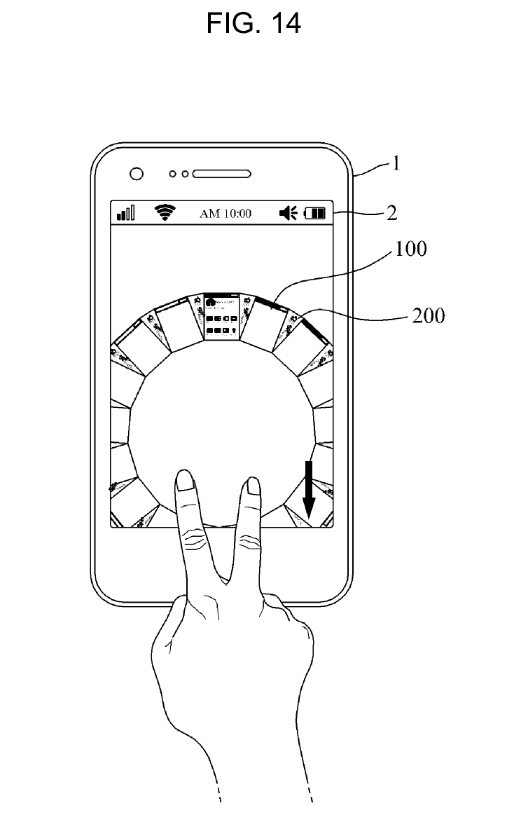

The apparatus 1 for outputting an additional page according to the present invention is characterized by allowing a user to freely adjust the size of a note 100 outputted on the screen of the display unit 2 at various ratios in order to solve those problems. That is, as illustrated in FIG. 12, when a user touches the display unit 2 at a plurality of points, as illustrated in FIG. 12, and then drags the fingers in parallel in one direction (down in this embodiment), as illustrated in FIG. 13, the note 100 and the additional page 200 are reduced. When the user further drags the fingers in the state illustrated in FIG. 13, the note 100 and the additional page 200 are further reduced and several notes 100 and additional pages are outputted on one screen, as illustrated in FIG. 14.

On the contrary, when a user touches the display unit 2 at a plurality of points and drags the fingers in another direction (for example, upward), the note 100 and the additional page 200 are gradually enlarged, such that one note 100 fully fills the screen of the display unit 2, as illustrated in FIG. 12.

On the other hand, when a signal for dragging or sweeping in the arrangement direction of the notes 100, with the notes 100 and the additional pages 200 reduced, as illustrated in FIGS. 13 and 14, the notes 100 and the additional pages 200 are turned around the center point of the arrangement of the notes 100, so the user can quickly and exactly find the note 100 that he/she wants to see. When the notes 100 are reduced less, as illustrated in FIG. 13, a user can easily know the contents in the notes 100, but has difficulty in quickly searching the notes 100 because a smaller number of notes 100 are outputted on one screen. Further, when the notes 100 are reduced much, as illustrated in FIG. 14, a plurality of notes 100 is outputted on one screen 100, so the user can quickly search the notes 100, but has difficulty in knowing the contents in the notes 100. Accordingly, a user can quickly and exactly search notes 100 while freely adjusting the size of the notes 100.

When a user finds a desired note 100 while searching notes 100, with the notes 100 and the additional pages 200 reduced, and touches the note 100, the touched note 100 is enlarged into the initial state, that is, enlarged and outputted such that it fully fills the screen of the display unit 2. Further, as illustrated in FIGS. 13 and 14, when the notes 100 and the additional pages 200 are reduced, not only the notes 100, but several pieces of the additional pages 200 are outputted, so a user can search specific additional pages 200 while turning the circularly arranged notes 100. When a user touches any one additional page 200 while searching additional pages 200, the notes 100 and the additional pages 200 are turned so that the selected additional page 200 is moved to the center of the screen and the notes 100 at the left and right sides of the selected additional page 200 disappear away to the left and right sides of the screen, such that only the additional page 200 selected by the user is enlarged and outputted on the screen. The process of enlarging an additional page 200 selected by a user to fully fill the screen of the display unit 2 was described above with reference to FIGS. 7 to 11, so the detailed description is not provided.

The size of a note 100 outputted on the screen of the display unit 2 may be adjusted in various ways other than the way illustrated in FIGS. 12 to 14, that is the way of touching the display unit at a plurality of points and then dragging the fingers in parallel.

For example, a pinch-zoom type may be used, that is, the size of a note 100 may increase or decrease, when a user touches the display unit 2 with two contact objects (fingers in this embodiment) and closes or opens the contact objects. The pinch-zoom type for adjusting the size of an output image has been used in terminals with a touch screen such as a smartphone, so it is not described in detail.

Further, the size of note 100 may increase or decrease in a dragging direction, when a user double taps the display unit 2 (continuously touches it two times) with a touch object and then dragging the touch object. That is, a note 100 may be reduced, when a user double taps the display unit 2 and then drags down a finger with a touch object on the display unit 2, and it may be enlarged, when a user double taps the display unit 2 and then drags up a touch object.

The size of a note 100 outputted on the screen of the display unit 2 may be adjusted by several methods obtained by combining touching and dragging.

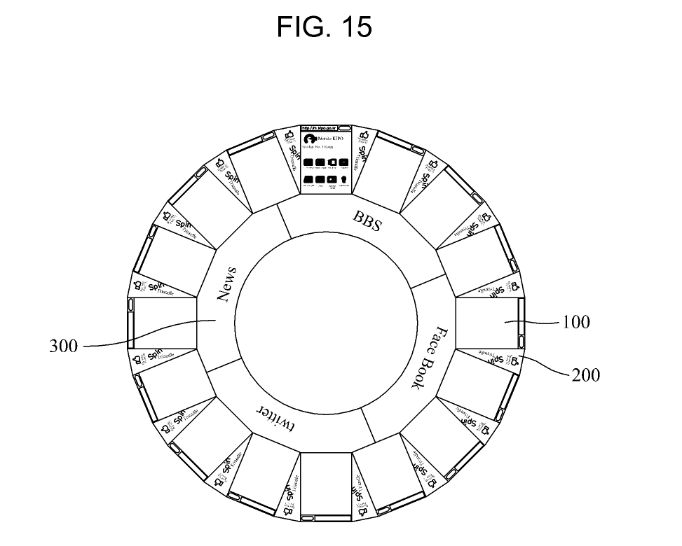

FIG. 15 is a diagram illustrating arrangement of notes 100.

Notes 100 outputted on the display unit 2 of the apparatus 1 for outputting an additional page according to the present invention are notes 100 selected in advance by a user and then arranged. Further, the notes 100 are sequentially shown on the screen in accordance with the arrangement order set by the user. The notes 100 may be arranged circularly and moved along an arc, that is, the arrangement pattern of the notes, as illustrated in FIG. 15, in order that a user can sequentially see all the notes 100 even if he/she moving them only in a predetermined direction.

Further, notes 100 kept by a user may be grouped for each kind of output contents, as illustrated in FIG. 15, and group name sections 300 for showing the kinds of the notes 100 maybe outputted on the display unit 2. When the group name sections 300 are outputted, as described above, a user can more quickly find desired notes 100 and more simply manage the kept notes 100.

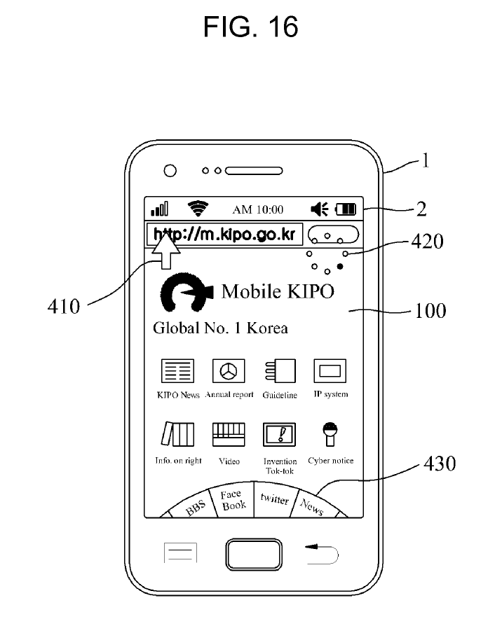

FIG. 16 is a diagram illustrating a display unit added with a function button.

Various kinds of function buttons such as an upper menu button 410 for moving the upper menus and a page control button 420 for quickly changing output notes 100 maybe added on the screen of the display unit 2. The page control button 420 is composed of small circles showing the currently kept notes 100 and arranged circularly, and the circle corresponding to the note 100 currently outputted on the screen of the display unit 2 may be colored to be discriminated from other circles. A user can bring out a note 100 on the screen of the display unit 2 by touching the circle corresponding to the note 100 of the circles of the page control button 420.

A navigation bar 430 showing where notes 100 are arranged may be provided on the screen of the display unit 2. For example, when a user wants to select notes 100 in a group ‘news’, with notes 100 in a group ‘twitter’ currently outputted, the user can know that the notes 100 in the group ‘news’ are arranged at the right side, from the navigation bar 430, such that he/she can more simply find desired notes 100 by moving the notes currently outputted to the left side.

The method of outputting an additional page according to the present invention can be implemented by computer-readable codes on a computer-readable recording medium. The computer-readable recording medium includes all kinds of recording media storing data readable by a computer system. The computer-readable recording medium may be ROM, RAM, CD-ROM, magnetic tape, a hard disc, a floppy disc, and an optical data storage, and may be implemented in a carrier wave type (for example, transmitted by the internet). The computer-readable recording mediums maybe distributed to computer systems that are connected through a network and may store and execute computer-readable codes in a division type. Further, functional programs, codes, and code segments for implementing the control method may be easily inferred by programmers in the art.

As set forth above, according to exemplary embodiments of the invention, by using the apparatus for outputting an additional page, the method of outputting an additional page, and a recording medium having a program for implementing the method according to the present invention, it is possible to output an additional page without covering an image with a note, selectively output advertisements in an additional page in accordance with user's inclination, and expose an additional page to the view of a user, thereby improving usability of an additional page.

While the present invention has been illustrated and described in connection with the exemplary embodiments, it will be apparent to those skilled in the art that modifications and variations can be made without departing from the spirit and scope of the invention as defined by the appended claims.

1. A method of outputting an additional page, comprising:
a first step of receiving a note change signal for changing a note current outputted on a display unit; and
a second step of moving a first note displayed on the display unit to gradually disappear to a side on a screen, moving a new second note to gradually appear on the screen sequentially from the first note, and outputting an additional page between the two notes.

2. The method of claim 1, further comprising:
a third step of receiving a signal for enlarging the second page, with the second page outputted;
a fourth step of gradually removing the notes on the screen and gradually enlarging the second page on the screen;
a fifth step of receiving a signal for returning the additional page; and
a sixth step of returning the areas for outputting the note and the additional page to the state before the third step.

3. The method of claim 1, wherein the notes outputted on the display unit are notes selected in advance by a user and then arranged, and
the second step sequentially shows the notes on the screen in accordance with an arrangement order set by the user, and the notes are arranged circularly and moved along an arc and the additional page is outputted in a triangular shape of a fan shape between adjacent two notes.

4. (canceled)

5. The method of claim 1, wherein the notes are grouped in accordance with the kinds of their contents and group name sections showing the kinds of the notes are additionally displayed.

6. The method of claim 1, wherein a notice or an advertisement is outputted on the additional page, and an advertisement designated for the contents of a note outputted on the display unit is outputted on the additional page.

7. (canceled)

8. (canceled)

9. (canceled)

10. The method of claim 1, wherein when a user inputs a signal for enlarging an image and a signal for reducing an image, a note and an additional page outputted on the display unit are enlarged and reduced, and when a user inputs a signal for reducing an image, three or more notes are outputted on the display unit in a predetermined arrangement pattern.

11. The method of claim 10, wherein the display unit is a touch screen, and when a user touches the display unit at a plurality of points and drags the points in parallel in a predetermined direction, the note and the additional page are reduced or enlarged in the dragging direction.

12. (canceled)

13. (canceled)

14. The method of claim 2, wherein the display unit is a touch screen and the note change signal in the first step is considered as a sweeping signal that is inputted to the display unit, and the third step considers that a signal for enlarging an additional page is inputted, when a contact object inputting the sweeping signal is separated from the display unit or sweeping by the contact object is stopped over a predetermined time.

15. (canceled)

16. A computer-readable recording medium that keeps a program for performing the method of claim 1.

17. An apparatus for outputting an additional page, comprising:
a display unit;
an input unit that receives a note change signal for changing a note outputted on the display unit to another note; and
a control unit that controls output of the display unit so that a first note outputted on the display unit moves and gradually disappears to a side, a new second note moves and gradually appears on a screen sequentially from the first note, and an additional page is outputted between the two notes, when the note change signal is inputted to the input unit.

18. The apparatus of claim 17, wherein the control unit controls output of the display unit so that notes selected in advance by a user are sequentially outputted, and on the display unit, a plurality of notes are arranged and outputted circularly, and when the note change signal is inputted, the notes are moved along an arc and the additional page is outputted in a triangular shape or a fan shape between two adjacent notes.

19. (canceled)

20. The apparatus of claim 17, wherein the notes are grouped in accordance with the kinds of their contents and group name sections showing the kinds of the notes are outputted on the display unit.

21. (canceled)

22. The apparatus of claim 17, wherein a notice or an advertisement is outputted on the additional page, and an advertisement designated for the contents of a note outputted on the display unit is outputted on the additional page.

23. The apparatus of claim 22, wherein the control unit transmits information about a note outputted on the display unit to an advertisement transmission server, the advertisement transmission server selects and transmits an advertisement designated for the note of which the information is received to the control unit, and the control unit outputs the advertisement transmitted from the advertisement transmission server to an additional page.

24. The apparatus of claim 22, wherein when there is no advertisement designated for the contents of a note outputted on the display unit, a default advertisement is outputted on the additional page.

25. The apparatus of claim 17, wherein the display unit enlarges, reduces, and then outputs the note and the additional page when a signal for enlarging an image and a signal for reducing an image are inputted, and outputs three or more notes in a predetermined arrangement pattern when a signal for reducing an image is inputted.

26. The apparatus of claim 25, wherein the display unit is a touch screen and reduces or enlarges and outputs the note and the additional page in a dragging direction, when two or more contact objects touch the display unit at a plurality of points and then are dragged in parallel in a predetermined direction.

27. The apparatus of claim 25, wherein the display unit is a touch screen and reduces or enlarges and outputs the note and the additional page in a dragging direction, when a contact object double taps the display unit and then dragged on the display unit.

28. The apparatus of claim 25, wherein the notes and the additional page are reduced and any one of the note and the additional page is touched, the touched note or the additional page is enlarged and outputted.

29. The apparatus of claim 17, wherein the display unit is a touch screen and the input signal recognizes a sweeping signal inputted to the touch screen as a note change signal, and the input unit determines that a signal for enlarging a secondary signal is inputted, when a contact object inputting a sweeping signal is separated from the display unit or sweeping of the contact object is stopped over a predetermined time.

30. (canceled)
